(19) United States
(12) Patent Application Publication
(10) Pub. No.: US 2024/0169106 A1
(43) Pub. Date: May 23, 2024

(54) System for Planning a Room and/or Surface, and Use of a Genetic Algorithm

(71) Applicant: Siemens Aktiengesellschaft, München (DE)

(72) Inventor: Rebecca Johnson, München (DE)

(73) Assignee: Siemens Aktiengesellschaft, München (DE)

(21) Appl. No.: 18/546,328

(22) PCT Filed: Jan. 28, 2022
(86) PCT No.: PCT/EP2022/052095

§ 371 Date: Aug. 14, 2023

(30) Foreign Application Priority Data
Feb. 15, 2021 (EP) 21157084.1

(51) Int. Cl. G06F 30/13; G06F 30/27

(52) U.S. Cl. CPC G06F 30/13; G06F 30/27

(57) ABSTRACT

Various embodiments of the teachings herein include a system for automated distribution of a number of predetermined objects in a room and/or on a surface. The system may include: a module for inputting and/or generating data; a module for outputting and/or presenting solutions; and interfaces for transmitting the data to a storage unit connected to a processor configured to carry out a genetic algorithm. The genetic algorithm uses the data and initially provides a generation of solutions. The processor evaluates and selects among the solutions based on their progressiveness then recombines the selected solutions. The procedure repeats and provides the most progressive solutions to an artificial intelligence and/or to a neural network which uses the solutions to generate new rules and transfers the most progressive solutions to the processor for refinement of the algorithm.

### CROSS-REFERENCE TO RELATED APPLICATIONS

This application is a U.S. National Stage Application of International Application No. PCT/EP2022/052095 filed Jan. 28, 2022, which designates the United States of America, and claims priority to EP Application No. 21157084.1 filed Feb. 15, 2021, the contents of which are hereby incorporated by reference in their entirety.

### TECHNICAL FIELD

The present disclosure relates to automated planning. Various embodiments of the teachings herein may include methods and/or systems for planning a room and/or surface, in particular an automated and computerized system.

### BACKGROUND

Enclosed space in general and in particular that with good infrastructure, in large cities, and/or on factory sites is costly and is to be optimally used. This is also the case with usable surfaces, and optimized utilization of the available surfaces is also the subject matter of detailed planning here. For example, equipping a printed circuit board or a circuit board is also carried out after prior planning with incorporation of the provided terminals, etc.

When equipping a surface, for example a circuit board and/or furnishing an interior, whether for a residential building, an office building, a warehouse, a theater, a fabrication line, a fabrication site, and/or for another interior, similar questions arise again and again. In general, various technicians will be incorporated in the room planning, which all introduce various aspects of the room utilization/room design in the planning.

For example, there are interior designers, who introduce aesthetic aspects into the planning. Then, there are technicians, who observe the position of the individual machines in relation to one another under the aspect of the process sequence in the case of factory planning. Furthermore, requirements for the location of the machines, desks, laboratory tables, etc. are placed with respect to their orientation in relation to the supply lines, heaters, windows, room ventilation, etc. Finally, there is also the space requirement of the individual objects, such as machines, tables, chairs, which are to be housed in the room, and the individual requirements, for example, cooling units not too close to the heater and not in direct sunlight, . . . etc. All of these aspects are reviewed and discussed in hours long meetings, until finally a solution which takes into consideration all aspects in a satisfactory manner is designed and implemented.

In particular during a pandemic, the boundary conditions can also change suddenly and there is the need to provide solutions at short notice for room planning and distributing the objects under changed conditions.

### SUMMARY

The teachings of the present disclosure include strategies for acquiring these boundary conditions for planning rooms and surfaces in an automated manner as well as solutions for planning a room or surface in an automated manner. For example, some embodiments of the teachings herein include a system for automated distribution of a number of predetermined objects in a room and/or on a surface, comprising: one or more modules for inputting and/or generating data of a first, second, and third type, wherein data of the first type relate to the room and/or the surface, wherein data of the second type relate to the parameters, patterns, rules, regulations, wherein data of the third type relate to the objects, and one or more modules for outputting and/or presenting solutions, one or more interface (s) for transmitting the data of the first, second, and third type to at least one storage unit connected to a processor, wherein the at least one processor is configured to carry out a genetic algorithm, characterized in that the genetic algorithm retrieves the data of the first, second, and third type from the storage unit, processes them in a computerized manner, and initially provides a generation of solutions in an automated manner, wherein the solutions of the first and the following generation are evaluated and selected with regard to their progressiveness with respect to predetermined parameters, then after completed selection, the selected solutions are recombined and the procedure repeating the genetic algorithm passes through a loop, in which the calculated solutions are evaluated, selected, and recombined again and again with respect to their progressiveness, wherein at least one interface is provided, via which the most progressive solutions of a generation are transferable to an artificial intelligence and/or to a neural network, wherein the artificial intelligence and/or the neural network uses the most progressive solutions to generate new rules for distributing a number of predetermined objects in a room and/or on a surface, which are then transferred to the processor for refinement of the genetic algorithm, and at least one interface is provided, by which a number of solutions optimized with regard to the predetermined parameter or parameters is transferable to the modules for outputting and/or presenting the solutions, wherein the arrangement of the predetermined objects in a room and/or on a surface is at least partially predetermined by these solutions.

In some embodiments, the surface on which the distribution of a number of predetermined objects is solved in an automated manner is a circuit board.

In some embodiments, the room in which the distribution of a number of predetermined objects is solved in an automated manner is a factory hall.

In some embodiments, the room in which the distribution of a number of predetermined objects is solved in an automated manner is an office room.

In some embodiments, data of the first type are generated in an automated manner by a module for room identification.

In some embodiments, the module is a laser scanner.

In some embodiments, at least one interface to a processor, which is configured to execute computer-aided design (CAD), is provided.

In some embodiments, the presentation of each generation of solutions is provided.

In some embodiments, the module for presentation is a display device such as a monitor.

In some embodiments, the optimization takes place with respect to multiple parameters simultaneously.

In some embodiments, the parameters have different weighting.

As another example, some embodiments include the use of a genetic algorithm for optimizing the distribution of a number of predetermined objects according to selectable parameters, wherein the objects are to be arranged according to object-related rules on a defined surface and/or in a predetermined room, such that solutions are presented in an automated and computerized manner, and wherein the arrangement of the predetermined objects in a room and/or on a surface is at least partially predetermined by these solutions.

In some embodiments, the predetermined room is an office room and/or a factory hall.

In some embodiments, the predetermined surface is a circuit board.

In some embodiments, the genetic algorithm is carried out in a computerized manner via an interface configured for this purpose by means of an artificial intelligence and/or by means of a neural network.

### DETAILED DESCRIPTION

Some embodiments of the teachings herein include the use of a genetic algorithm for optimizing the distribution of a number of predetermined objects according to selectable parameters, wherein the objects are to be arranged according to object-related rules on a surface and/or in a predetermined room, such that solutions are presented in an automated and computerized manner, wherein the arrangement of the predetermined objects on the surface and/or in the room is predetermined at least in part by the solutions.

For example, some embodiments include a system for automated distribution of a number of predetermined objects in a room and/or on a surface, comprising the following:
one or more modules for inputting and/or generating data of a first, second, and third type,
   wherein data of the first type relate to the room and/or the surface,
   wherein data of the second type relate to the parameters, patterns, rules, regulations,
   wherein data of the third type relate to the objects, and
one or more modules for outputting and/or presenting solutions,
one or more interface (s) for transmitting the data of the first, second, and third type to at least one storage unit connected to a processor, wherein the at least one processor is configured to carry out a genetic algorithm, characterized in that
the genetic algorithm retrieves the data of the first, second, and third type from the storage unit, processes them in a computerized manner, and initially provides a generation of solutions in an automated manner, wherein the solutions of the first and the following generation are evaluated and selected with regard to their progressiveness with respect to predetermined parameters, then
after completed selection, the selected solutions are recombined and the procedure repeating the genetic algorithm passes through a loop, in which the calculated solutions are evaluated, selected, and recombined again and again with respect to their progressiveness, wherein
at least one interface is provided, via which the most progressive solutions of a generation are transferable to an artificial intelligence and/or to a neural network,
wherein the artificial intelligence and/or the neural network uses the most progressive solutions to generate new rules for distributing a number of predetermined objects in a room and/or on a surface, which are then transferred to the processor for refinement of the genetic algorithm, and
at least one interface is provided, by which a number of solutions optimized with regard to the predetermined parameter or parameters is transferable to the modules for outputting and/or presenting the solutions, wherein the arrangement of the predetermined objects in a room and/or on a surface is at least partially predetermined by these solutions.

A system can store and process all data which are required for calculating suitable surface and/or room equipment, so that, by one or more appropriately configured processor (s), the execution of a genetic algorithm after the initiation of solutions by evaluation, selection, and recombination is usable in an automated manner, for example, via an artificial intelligence, as the foundation for generating further solutions for planning a surface and/or room. These solutions are then technically implemented in the context of a specific distribution of the predetermined objects in a room and/or on a surface.

In some embodiments, the system comprises in particular one or more processor (s), which is configured so that it is capable of executing a genetic algorithm.

In some embodiments, the system comprises one or more storage unit (s) having respective interfaces to one or more processors, in which data on the room and/or on the surface, data on the objects, and object-related rules, parameters, and specifications for optimization and for recombination as solutions identified as suitable, which each represent the foundation of the calculation of further solutions in an iterative method, are storable and retrievable.

In some embodiments, the system comprises modules which are capable of acquiring and/or generating data and providing these data to at least one of the storage units of the system, from which the processor retrieves the data.

The system thus comprises one or more storage unit (s), in which data, in particular
at least one number of data of a first type relating to the room to be equipped and/or the surface to be equipped,
at least one number of data of a second type relating to parameters, for example, the distribution and/or arrangement rules, regulations, and/or patterns to be followed, and
at least one number of data of a third type relating to objects to be distributed and their object-related rules and/or regulations,
are provided for the processor (s) of the system for processing.

In operation, the processor retrieves the data which have reached a storage unit of the system via the modules via a suitable interface. The processor then starts the iterative method using these inputs, in which, with incorporation of all given data of the first, second, and third type, in consideration of the rules and boundary conditions, it calculates and presents solutions for how the distribution of the objects could appear in the given room and/or on the given surface under the predetermined rules. The iterative method makes use here of a comparative progress check, thus an evaluation in which it is checked which of the solutions are superior to other solutions with respect to predetermined parameters, e.g., room utilization, distance between the tables, flexibility, confidentiality, well-being, feng shui conformity, etc. These solutions are then selected for a user and recombined by a genetic algorithm. New generations of solutions are in turn generated from these recombinations, which are then likewise reevaluated, selected, and then recombined. These loops are continued by the genetic algorithm until it is terminated. The presentation of the solutions preferably takes place in real time, thus each generation of solutions is transferred to the modules for outputting the solutions and/or for presenting the solutions. Users are thus optionally incorporated in the selection, whose selection is useful for training the artificial intelligence.

To refine the genetic algorithm, the selected solutions are transferred to a neural network and/or an artificial intelligence—AI—of the system—again via corresponding interfaces of the system. The AI and/or a user can select the solutions manually or in an automated manner therefrom, which he wishes to use for the further iterative method as the foundation for recombination. The artificial intelligence and/or the neural network can develop further rules for the iterative method therefrom and store these new rules as data of the “second type” or transfer them to the processor, respectively.

The iteration steps are presented at the same time via output devices, wherein the user can change, for example, the parameters according to which optimization is to be performed. When the presented solutions are already optimal with respect to, for example, the room utilization of an office by distribution of desks, the user can thus in the running method have the iteration loop optimized according to implementation of a specific angle between desk and window. This regulation can also take place continuously, so that one regulator is shut down and the other is started up at the same time.

After a predetermined number of iteration steps, the genetic algorithm is terminated and the system presents one or more optimum solutions via the modules for outputting the solutions, which are then transferred to a corresponding display and/or playback device and are displayable thereby. For example, the solutions can be viewed on a display device such as a monitor and/or received as a printout. For this purpose, the system comprises a printer and a display device.

The solutions are provided and/or transferred, for example, in parallel and/or after processing on a display device of a machine for automated equipment of a circuit board, so that the solutions form the basis for how the predetermined objects are actually arranged in a room and/or on a surface.

The system comprises one or more modules by which data of the “first type” with respect to the room and/or the surface are acquired and/or generated. For example, the system comprises a 3D camera for providing the data of the first type with respect to the space as point cloud (s), in particular as 3D point cloud (s). Special room conditions, as exist, for example, in old buildings, can also be acquired here in particular. Laser scanning methods and devices for acquiring and/or generating the data of the first type are also outstandingly suitable. With respect to equipping a surface, such as a circuit board with electronic components, these data can also relate to the surface quality, the dimensions, the predetermined conductor tracks, etc.

“Circuit board” stands here for a printed circuit board, a carrier element on which electronic components such as transistors, resistors, capacitors, chips, etc. are arranged.

The data of the first type define the conditions of the room and/or the surface. These can be manually input and/or generated, stored and transmitted in a computerized or automated manner by means of modules such as camera and/or laser scanner.

“Second data” designates the parameters, specifications, boundary conditions, regulations, patterns, and/or rules which distinguish the interplay of the objects in the room and/or on the surface. These also include the parameter or parameters on the basis of which the judgment of the progressiveness of the solution found and finally the optimization by the genetic algorithm takes place.

The optimization of the solutions found in a computerized manner for distributing a number of predetermined objects in a room/on a surface will take place not only according to one predetermined parameter, but rather according to multiple parameters simultaneously. It is probable in this case that not all parameters have the same importance, so that the weighting of the parameters will be different. Since the method which is executed by a system according to the invention is an iterative method, new solutions come into play again and again and it is therefore possible to change the weighting of the parameters or the parameters as such during the method.

Examples of parameters, for example, in the room planning of an office, are: specifications relating to desks per unit of area, cabinet area per employee, fire extinguishers every 5 m, avoiding groups made up of more than 9 desks, distance of the chair to the window, pictures on the wall, feng shui rules, etc. . . . The more accurately and completely these data, representing the parameters, of the second type are provided to the system by manual or automated input, the greater the effect of the automated optimization steps on the solutions found.

The data of the “third type” are data relating to the objects to be distributed. In the above-mentioned example of the equipping of the office room, these are the tables, desks, desk chairs, wastebaskets, trays, etc. which are to be distributed in the office. The acquisition and generation of these object data of the third type can also, for example, be manually input again here, transferred in an automated manner via corresponding product data sheets, and/or can be carried out by means of laser scanner or 3D camera. These data of the third type also include the rules associated with the respective object. These are object-related specifications to be taken into consideration, such as
one chair fits in front of each desk,
each monitor on a desk requires a connection,
the desk is at a special angle in relation to the window, the wall, etc.

The genetic algorithm presents solutions in which the distribution of the objects corresponds to the object-related rules, wherein computerized specifications can be made as to whether rules are indispensable—such as the chair in front of the desk—or only advantageous—such as following the feng shui rules.

The system can also comprise an interface to a computer-aided design (CAD) system, in particular if the rooms or the surface is not fixedly defined, but rather is modifiable.

A genetic algorithm is a computerized iterative method which presents solutions by calculation in which fundamentally no improvement of existing solutions is guaranteed, but which also open up a search area by mutation and recombination in which by selection, which can take place manually or by means of an artificial intelligence, a direction is predetermined which results in the global optimum upon successful conception.

In the present case, “parameter” designates a variable which designates a program-external set influencing factor. These relate in particular to specific limiting values and/or selection conditions.

In the present case, for example, a layout and/or a plan of how and where which objects can be distributed on a surface or in a room is designated as a “distribution of a number of predetermined objects in a room and/or on a surface” and/or as a “solution”.

“Artificial intelligence” describes a device for machine learning. The artificial intelligence receives, in a neural network, solutions with evaluation, wherein the artificial intelligence is trained by this evaluation and finally uses it to derive new rules therefrom, which it provides to the genetic algorithm again for evaluation and selection of the next generation of solutions.

A “processor” can be understood in connection with the invention, for example, as a machine, an artificial intelligence having a neural network, and/or an electronic circuit. A processor can be in particular a central processing unit (CPU), a microprocessor, or a microcontroller, for example, an application-specific integrated circuit or a digital signal processor, possibly in combination with a storage unit for storing program commands, etc. A processor can also be, for example, an IC (integrated circuit), in particular an FPGA (field programmable gate array) or an ASIC (application-specific integrated circuit), or a DSP (digital signal processor), or a graphic processing unit (GPU). A processor can also be understood as a virtualized processor, a virtual machine, or a soft CPU. It is preferably a programmable processor which is equipped with configuration steps for executing the mentioned method according to the invention or is configured using configuration steps such that the programmable processor implements the features according to the invention of the method or the modules.

A “module” may include, for example, as a laser scanner, a 3D camera, a processor, and/or a storage unit for storing program code. For example, the processor is especially configured to execute the program codes such that the processor executes functions in order to implement or carry out one or more of the methods described herein. The respective modules can also be designed, for example, as separate or independent modules. For this purpose, the corresponding modules can comprise further elements, for example. These elements are, for example, one or more interfaces (e.g., database interfaces, communication interfaces—e.g., network interface, WLAN interface) and/or an evaluation unit (for example a processor) and/or a storage unit. Data can be exchanged, for example, by means of the interfaces (e.g., received, transferred, transmitted, or provided). By means of the evaluation unit, data can be compared, checked, processed, assigned, or calculated, for example, in a computerized and/or automated manner.

By means of a storage unit, data can be stored, retrieved, or provided in the system, for example, in a computerized and/or automated manner.

“Computerized” or “computer-based” includes an implementation in which a processor executes at least one method step of the method. For example, “computerized” or “computer-based” is also to be understood as “computer-implemented”.

“Provision”, in particular with respect to data, metadata, and/or other information can be, for example, a computerized provision. In some embodiments, the provision takes place via an interface (e.g., a database interface, a network interface, an interface to a storage unit). Via this interface, for example, corresponding data and/or information can be transferred and/or transmitted and/or retrieved and/or received upon the provision. “Provision” can also be understood in connection with the invention, for example, as loading or storing, for example, a transaction with corresponding data. “Provision” can also be understood, for example, as a transmission (or sending or transfer) of corresponding data from one node to another node.

The teachings of the present disclosure allow cumbersome optimization processes over by artificial to be taken intelligence. For this purpose, first data relating to a surface or a room, together with second data relating to a regulation for how the surface and/or the room is to be equipped are provided with third data relating to objects and object-relating rules to a genetic algorithm, which optimizes the distribution of the objects in the room and/or on the surface by an iterative method and presents the optimized solutions to the user, who then may describe his arrangement of the predetermined objects in the room and/or on the surface at least partially thus oriented.

What is claimed is:

1. A system for automated distribution of a number of predetermined objects in a room and/or on a surface, the system comprising:
one or more module for inputting and/or generating data of a first, second, and third type,
wherein data of the first type relate to the room and/or the surface,
data of the second type relate to the parameters, patterns, rules, regulations, and
data of the third type relate to the objects;
one or more modules for outputting and/or presenting solutions;
one or more interface for transmitting the data of the first, second, and third type to at least one storage unit connected to a processor, wherein the processor is configured to carry out a genetic algorithm;
the genetic algorithm retrieves the data of the first, second, and third type from the storage unit, processes them in a computerized manner, and initially provides a generation of solutions in an automated manner;
wherein the processor evaluates solutions of the first and the following generation and selects among the solutions based on their progressiveness with respect to predetermined parameters; then
recombines the selected solutions;
wherein the procedure repeating the genetic algorithm passes through a loop, in which the calculated solutions are evaluated, selected, and recombined again and again with respect to their progressiveness;
the processor transfers the most progressive solutions of a generation to an artificial intelligence and/or to a neural network;
the artificial intelligence and/or the neural network uses the most progressive solutions to generate new rules for distributing a number of predetermined objects in a room and/or on a surface, and transfers the most progressive solutions to the processor for refinement of the genetic algorithm; and
the processor transfers a number of solutions optimized with regard to the predetermined parameter or parameters to the modules for outputting and/or presenting the solutions;
wherein the arrangement of the predetermined objects in a room and/or on a surface is at least partially predetermined by the solutions transferred to the one or more modules.

2. The system as claimed in claim 1, wherein the surface comprises a circuit board.

3. The system as claimed in claim 1, wherein the room comprises a factory hall.

4. The system as claimed in claim 1, wherein the room comprises an office room.

5. The system as claimed in claim 1, wherein one of the one or more modules comprises a module for room identification generates data of the first type.

6. The system as claimed in claim 5, wherein the module is a laser scanner.

7. The system as claimed in claim 1, wherein one of the at least one interfaces is configured to communicate with a processor programmed to execute computer-aided design (CAD).

8. The system as claimed in claim 1, further comprising a presentation of each generation of solutions.

9. The system as claimed in claim 1, wherein the module for presentation comprises a display device.

10. The system as claimed in claim 1, wherein the optimization takes place with respect to multiple parameters simultaneously.

11. The system as claimed in claim 10, wherein the parameters have different weighting.

12. A method comprising:
using a genetic algorithm for optimizing the distribution of a number of predetermined objects according to selectable parameters;
wherein the objects are to be arranged according to object-related rules on a defined surface and/or in a predetermined room, such that solutions are presented in an automated and computerized manner; and
wherein the arrangement of the predetermined objects in a room and/or on a surface is at least partially predetermined by these solutions.

13. The use as claimed in claim 12, wherein the predetermined room comprises an office room and/or a factory hall.

14. The use as claimed in claim 12, wherein the predetermined surface comprises a circuit board.

15. The use as claimed in claim 12, wherein the genetic algorithm is carried out in a computerized manner via an interface configured by means of an artificial intelligence and/or by means of a neural network.
